(19) United States
(12) Patent Application Publication
(10) Pub. No.: US 2026/0356522 A1
(43) Pub. Date: Nov. 12, 2026

(54) CONTAINER ASSEMBLY WITH SECURING MECHANISM

(71) Applicant: Perennial Autonomy, LLC, Menlo Park, CA (US)

(72) Inventors: David SCHNELLE, Palo Alto, CA (US); Christian Johan Owen HANDLEY, San Francisco, CA (US)

(21) Appl. No.: 19/672,521

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. B64U 80/70

(52) U.S. Cl. CPC B64U 80/70

(57) ABSTRACT

A transport container includes an interior compartment and a launch element extending within the interior compartment. The launch element is configured to hold a stack of mobile platforms thereon. The transport container includes a top moveable between an open position and a closed position. The open position of the top enables the mobile platforms to exit the interior compartment of the container. The transport container includes a securing mechanism operatively connected between the top and the launch element. The securing mechanism includes a concave segment configured to receive an end portion of the launch element therein when the top is in the closed position.

### CROSS-REFERENCE TO RELATED APPLICATIONS

This non-provisional utility application claims priority to provisional patent application number 63/960,687, entitled “CONTAINER ASSEMBLY WITH SECURING MECHANISM” and filed on Jan.14, 2026, provisional patent application number 63/815,810, entitled “LAUNCHING CONTAINER ASSEMBLY FOR MOBILE PLATFORMS” and filed on Jun. 1, 2025, provisional patent application number 63/807,413, entitled “LAUNCHING CONTAINER USING SUPPORTS FOR MOBILE PLATFORMS” and filed on May. 16, 2025, provisional patent application number 63/803,081, entitled “MOBILE PLATFORM DEPLOYMENT METHOD AND SYSTEM” and filed on May. 9, 2025, provisional patent application number 63/854,392, entitled “DUAL-PURPOSE BOOT AND METHOD OF MANUFACTURE” and filed on Jul. 30, 2025, provisional patent application number 63/910,760, entitled “MOBILE PLATFORM STACKING ASSEMBLY” and filed on Nov. 3, 2025, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Existing methods and systems for deploying mobile platforms exhibit a variety of technical limitations and disadvantages.

### SUMMARY

In an aspect, a transport container includes an interior compartment and a launch element extending within the interior compartment. The launch element is configured to hold a stack of mobile platforms thereon. The transport container includes a top moveable between an open position and a closed position. The open position of the top enables the mobile platforms to exit the interior compartment of the container. The transport container includes a securing mechanism operatively connected between the top and the launch element. The securing mechanism includes a concave segment configured to receive an end portion of the launch element therein when the top is in the closed position.

In another aspect, a transport container includes a body having an interior compartment. The transport container includes launch elements extending within the interior compartment. The launch elements are configured to hold stacks of mobile platforms thereon. The transport container includes a top moveable between an open position and a closed position. The open position of the top enables the mobile platforms to exit the interior compartment of the container. The transport container includes alignment mechanisms operatively connected between the body and the launch elements such that the alignment mechanisms hold the launch elements within the interior compartment in fixed positions relative to each other.

In another aspect, a method includes loading mobile platforms into an interior compartment of a transport container such that the mobile platforms are stacked on a launch element extending within the interior compartment, operatively connecting a securing mechanism between the launch element and a top of the transport container such that an end portion of the launch element is configured to be received within a concave segment of the securing mechanism when the top is in a closed position, and operatively connecting alignment mechanisms between the transport container and the launch elements such that alignment mechanisms hold the launch elements within the interior compartment in fixed positions relative to each other.

### BRIEF DESCRIPTION OF THE DRAWINGS

FIG. 1 is an isometric view illustrating a transport container assembly according to an implementation.

FIG. 2 includes elevational and side views of transport container assemblies according to an implementation.

FIG. 3 is an elevational schematic view of the transport container assembly shown in FIG. 1 according to an implementation.

FIG. 4 is a plan schematic view of the transport container assembly shown in FIG. 1 according to an implementation.

FIG. 5 is an isometric view of launch elements according to an implementation.

FIG. 6 is an elevational schematic view illustrating a transport container assembly according to an implementation.

FIGS. 7-11 are isometric views illustrating a transport container assembly according to an implementation.

FIG. 12 is an elevational schematic view illustrating a transport container assembly according to an implementation.

FIG. 13 is a flowchart illustrating a method according to an implementation.

FIG. 14 is a flowchart illustrating a method according to an implementation.

FIG. 15 is a schematic diagram illustrating an exemplary operating environment of the disclosure according to an implementation.

### DETAILED DESCRIPTION

Existing methods and systems for deploying mobile platforms exhibit a variety of technical limitations and disadvantages. For example, deployment of mobile platforms may present various challenges that compromise operational effectiveness, for example during transport and/or deployment. Existing deployment systems suffer from excessive movement of components that can potentially damage components of the system such as launch elements (guides, rails, rods, tubes, etc.), mobile platforms, and/or the like. For example, launch elements may suffer from uncontrolled movement (e.g., during transit and/or handling operations, etc.), which can cause warping, collisions between components, and/or potential failure of the launch system. Moreover, existing deployment systems suffer from misalignment issues that can prevent proper deployment and create structural stress on components of the deployments system. For example, known deployment systems have less efficient loading procedures and inconsistent placement that affects the overall system performance of the deployment system.

In contrast, aspects of the disclosure relate to a launch system that provides improved securing and alignment of mobile platforms and launch elements within a container (e.g., a shipping container, etc.), for example during transport and/or deployment of the mobile platforms. For example, the disclosure provides mechanisms that limit and/or reduce movement of, and thereby damage to, the launch elements and mobile platforms during transit (e.g., transport, etc.) operations such as, but not limited to, tilting, loading, unloading, and/or the like. In some examples, alignment mechanisms are provided for the launch elements, for example to reduce misalignment and/or reduce the structural stress experienced by the launch elements. In some examples, securing mechanisms are provided between the launch elements and a roof of the container, for example to limit and/or reduce movement of the launch elements, to limit and/or reduce warping of the launch elements, to limit and/or reduce collision between launch elements and/or mobile platforms, and/or the like.

Examples of applications of the subject matter disclosed herein include, but are not limited to, shipping applications, emergency response applications, research and development applications, launch service applications, security and/or surveillance applications, community monitoring applications, commercial applications, disaster response, environmental monitoring, military applications, and/or the like.

For example, shipping applications of the disclosure include commercial shipping operations to provide launch systems with more secure transport across international routes. In some examples, shipping containers carrying launch elements may experience movement during ocean transport, loading operations at ports, overland trucking, and/or the like. The securing and mechanisms disclosed herein reduce, limit, and/or prevent damage to the launch elements and the mobile platforms and improve the alignment and positioning of the launch elements when containers are opened for deployment of the mobile platforms.

In an example of emergency response applications, aspects of the disclosure are implemented in disaster response scenarios to provide more rapid deployment of launch systems, for example in a remote and/or challenging location. In some examples, emergency response teams transport launch equipment to areas affected by natural disasters and/or other emergencies, with the disclosed securing and alignment mechanisms improve the reliability, response time, and operation of equipment, for example despite relatively rough transport conditions and/or in scenarios where relatively rapid deployment is desired.

Research and development application examples include utilizing aspects of the disclosure in aerospace testing facilities. For example, aspects of the disclosure may be utilized to transport experimental launch systems between different test sites and/or laboratories. In some examples, research teams from the more consistent placement and alignment features of the disclosure when moving prototype launch equipment for various testing phases, for example increasing the ability of the launch elements to maintain alignment throughout transport.

Examples of commercial launch service applications include private launch service providers utilizing the disclosure for transporting launch equipment to various launch sites based on customer requirements and/or optimal launch windows. For example, aspects of the disclosure enable providers to maintain multiple launch locations while increasing the likelihood that equipment arrives in proper condition and can be relatively quickly deployed for time-sensitive launch operations.

Security and/or surveillance application examples include implementing aspects of the disclosure in security monitoring operations where launch systems are equipped with surveillance payloads, for example to improve strategic positioning and/or provide more rapid deployment capabilities. In some examples, security personnel utilize aspects of the disclosure to transport and deploy monitoring equipment to various observation points, for example with the disclosed securing mechanisms protecting relatively sensitive surveillance components during transport and the disclosed alignment systems enabling more precise positioning for coverage areas.

Another example of a security and/or surveillance application includes perimeter monitoring scenarios, where aspects of the disclosure facilitate the transport of launch-based security equipment to (e.g., remote, etc.) boundary locations of facilities, installations, properties, and/or the like. In some examples, the disclosure enables security teams to more quickly establish monitoring positions along extended perimeters, with the alignment mechanisms disclosed herein providing improved maintenance of surveillance payload orientations and the disclosed securing mechanisms better protecting equipment during transport across varied terrain conditions.

Another security and/or surveillance application example of the disclosure includes infrastructure protection. For example, aspects of the disclosure may be deployed for protecting infrastructure sites such as, but not limited to, power plants, communication facilities, transportation hubs, and/or the like. In some examples, aspects of the disclosure enable security operations to more rapidly transport and position launch systems carrying protective countermeasures, monitoring equipment, and/or the like, wherein the integrated securing mechanisms disclosed herein reduce, limit, and/or prevent damage to relatively sensitive security components during emergency deployment scenarios.

Event security is another security and/or surveillance application of the disclosure. For example, in relatively large-scale event security operations, aspects of the disclosure enable more rapid deployment of elevated surveillance platforms to provide monitoring coverage. In some examples, event security teams utilize the disclosure to transport launch equipment to various positions around venues, wherein the more consistent placement of the alignment mechanisms disclosed herein enable more reliable positioning of surveillance assets and the disclosed securing mechanisms better protect equipment during setup and breakdown operations.

Border security is another exemplary security and/or surveillance application of the disclosure. For example, aspects of the disclosure may be implemented in border security operations where mobile launch platforms carrying surveillance and/or detection equipment require deployment along extended frontier areas. In some examples, border security personnel utilize the disclosure to more quickly transport and position monitoring systems at strategic locations (e.g., with the alignment mechanisms disclosed herein better maintaining coverage angles, with the securing features disclosed herein better protecting relatively sensitive detection equipment during transport through challenging border terrain, etc.).

Examples of community monitoring applications of the disclosure include deploying mobile platforms for tasks such as crowd monitoring, search and rescue operations, area surveillance, and/or the like. Aspects of the disclosure enhance the ability to manage relatively large-scale events and/or emergency situations by providing more rapid aerial deployment capabilities while minimizing the necessity for extensive on-ground personnel.

Examples of commercial applications of the disclosure include deploying mobile platforms for fleet-based operations in agriculture, infrastructure inspection, logistics delivery services, and/or the like. Aspects of the disclosure enable companies to position mobile platform deployment stations strategically, for example offering adaptive solutions for reaching remote and/or difficult-to-access locations.

In disaster response scenarios, exemplary applications of the disclosure include launching mobile platforms for real-time damage assessment and/or to assist in coordinating rescue efforts. Mobile platforms can be more quickly deployed to survey affected areas, for example providing data to first responders and aiding in the efficient allocation of resources.

In some environmental monitoring examples of the disclosure, environmental monitoring agencies may employ aspects of the disclosure to more swiftly deploy mobile platforms for data collection and/or monitoring activities, such as wildlife tracking, pollution assessment, and/or the like. The mobility of the container grants unparalleled access to diverse environments, for example enabling vital data to be gathered from multiple sites with fewer logistical constraints.

Examples of military applications include military operations where launch systems require rapid transport and deployment in tactical environments. Military units could utilize the system for transporting missile launch equipment, artillery systems, and/or other launch platforms to forward operating bases, strategic positions, and/or the like. The securing mechanisms disclosed herein better maintain equipment integrity during transport (e.g., through challenging terrain, etc.), while the alignment mechanisms disclosed herein enable quicker deployment in combat situations where relatively precise positioning and more immediate operational readiness is desired.

Aspects of the disclosure operate in an unconventional manner at least by providing a transport container that includes an interior compartment and a launch element extending within the interior compartment. The launch element is configured to hold a stack of mobile platforms thereon. The transport container includes a top moveable between an open position and a closed position. The open position of the top enables the mobile platforms to exit the interior compartment of the container. The transport container includes a securing mechanism operatively connected between the top and the launch element. The securing mechanism includes a concave segment configured to receive an end portion of the launch element therein when the top is in the closed position.

Aspects of the disclosure operate in an unconventional manner at least by providing a transport container that includes a body having an interior compartment. The transport container includes launch elements extending within the interior compartment. The launch elements are configured to hold stacks of mobile platforms thereon. The transport container includes a top moveable between an open position and a closed position. The open position of the top enables the mobile platforms to exit the interior compartment of the container. The transport container includes alignment mechanisms operatively connected between the body and the launch elements such that the alignment mechanisms hold the launch elements within the interior compartment in fixed positions relative to each other.

Aspects of the disclosure operate in an unconventional manner at least by providing a method that includes loading mobile platforms into an interior compartment of a transport container such that the mobile platforms are stacked on a launch element extending within the interior compartment, operatively connecting a securing mechanism between the launch element and a top of the transport container such that an end portion of the launch element is configured to be received within a concave segment of the securing mechanism when the top is in a closed position, and operatively connecting alignment mechanisms between the transport container and the launch elements such that alignment mechanisms hold the launch elements within the interior compartment in fixed positions relative to each other.

Example technical solutions to the technical problems described herein include implementing the disclosed securing mechanisms between the launch elements and the roof of a container. The technical solution of the disclosed securing mechanism reduces, limits, and/or prevents movement of the launch elements during transit of the container. The technical solution of the disclosed securing mechanism provides the technical effect of reducing, limiting, and/or preventing damage to the launch elements during transport operations. The technical solution of the disclosed securing mechanism provides the technical effects of: reducing, limiting, and/or eliminating uncontrolled movement of the launch elements (e.g., along their length; lateral, radial, or curved movement of an end portion of a launch element; etc.); reducing, limiting, and/or preventing warping of the launch elements and/or collision between components (e.g., between launch elements, between mobile platforms, between launch elements and mobile platforms, etc.); and improving overall system performance through enhanced structural integrity during transit, shipping, and handling operations.

Aspects of the disclosure provide the technical solution of implementing the disclosed alignment mechanisms between launch elements and container roof structures. The technical solution of the disclosed alignment mechanism provides the technical effect of improving container loading procedures and provides more consistent placement of launch system components. The technical solution of the disclosed alignment mechanism provides the technical effect of reducing, limiting, and/or preventing misalignment issues that may compromise deployment of the mobile platforms. The technical solution of the disclosed alignment mechanism provides the technical effect of improving overall system performance through enhanced structural integrity during transit, shipping, and handling operations.

Examples of mobile platforms (e.g., mobile platforms 104, etc.) include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), aquatic vehicles (e.g., boats, ships, marine vehicles, freshwater vehicles, etc.), surface vehicles, submersibles, uncrewed aquatic vehicles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), missiles, rockets, projectiles, munitions, uncrewed mobile platforms, autonomous mobile platforms, and/or the like. In some examples, a transport container assembly as disclosed herein is used with one or more uncrewed, autonomous platforms.

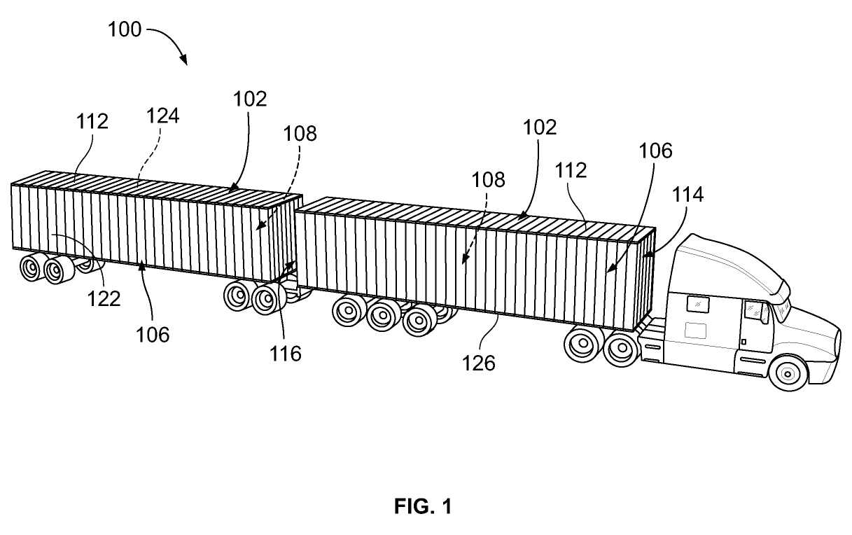

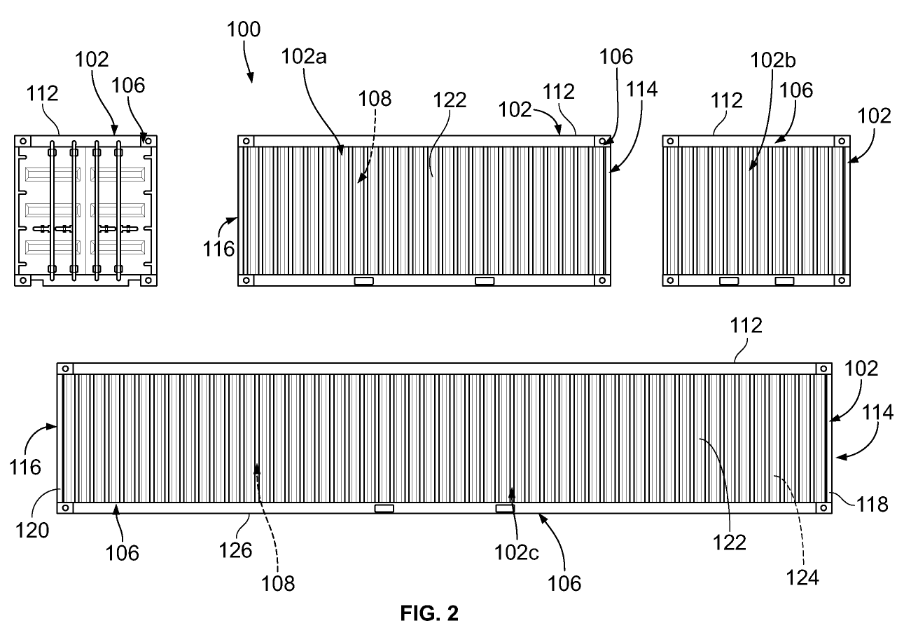

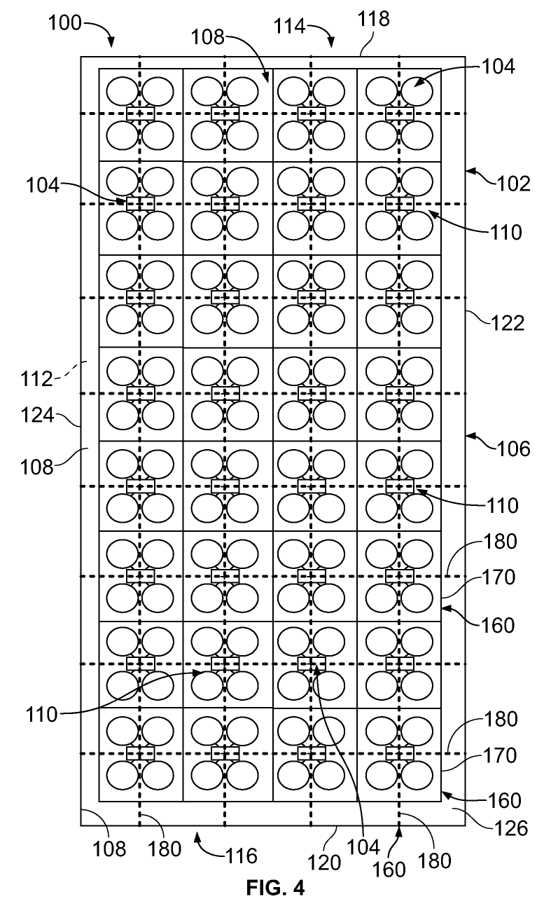

Referring to the figures, FIGS. 1-4 illustrate exemplary implementations of a transport container assembly 100. The transport container assembly 100 includes a shipping container 102 (e.g., an International Organization for Standardization (ISO) shipping container, etc.) and mobile platforms 104 (not visible in FIGS. 1 and 2). The transport container 102 includes a body 106 that includes an interior compartment 108 that is configured to hold one or more stacks 110 (not visible in FIGS. 1 and 2) of the mobile platforms 104 therein. As will be described below, and for example, the body 106 of the shipping container 102 includes a top 112 that opens to enable the mobile platforms 104 to launch directly from the shipping container 102 by exiting the interior compartment 108 through the open top 112. In the exemplary implementation of FIG. 4, the top 112 has been removed to illustrate an exemplary open position of the top 112. The transport container assembly 100 may be referred to herein as a “transport container” and/or a “launch system”. The shipping container 102 may be referred to herein as a “transport container” and/or a “launching container”.

In an example in which the shipping container 102 is an ISO shipping container, the shipping container 102 is a standard intermodal container for freight transport that complies with ISO standards (e.g., ISO standard 668:2020, etc.). In some examples, the shipping container 102 is a twenty-foot equivalent (TEU) container, for example a 1 TEU container (approximately 20 feet in length), a 2 TEU container (approximately 40 feet in length, also referred to as a forty-foot equivalent (FEU) container), a 2 TEU container that is approximately 45 feet in length, a 2.4 TEU container, a 2.65 TEU container, a ten-foot length equivalent container, and/or the like. For example, FIG. 1 illustrates two FEU containers 102 being pulled by a semi-trailer truck. In another example, FIG. 2 illustrates side and rear elevational views of a 1 TEU container 102a, a side elevational view of a ten-foot equivalent container 102b, and a side elevational view of a 2 TEU container 102c. In some examples, the ISO shipping container 102 is a High Cube (HC) container (with a standard height of approximately 2.6 meters), a Hi-Cube (HQ) container (with a standard height of approximately 2.9 meters), a half-height container (with a standard height of approximately 1.3 meters, and/or the like. FIG. 2 illustrates HC containers 102a, 102b, and 102c. The shipping container 102 may include any width, such as, but not limited to, approximately 2.4 meters wide, and/or the like.

The body 106 of the shipping container 102 extends a length from an end 114 to an end 116. The body 106 of the shipping container 102 includes end walls 118 and 120 at the ends 114 and 116, respectively. The body 106 includes side walls 122 and 124 that extend lengths from end 114 to the end 116. The body 106 of the shipping container 102 includes the top 112 and a bottom wall 126. The body 106 of the shipping container 102 extends a height from the bottom wall 126 to the top 112. For example, the side walls 122 and 124 and the end walls 118 and 120 extend heights from the bottom wall 126 to the top 112. Each of the ends 114 and 116 may be referred to herein as a “first” and/or a “second” end.

As described above, the top 112 of the shipping container 102 is configured to open. For example, at least a portion of the top 112 is configured to move between an open position (e.g., as shown in FIG. 4, etc.) and a closed position (e.g., as shown in FIGS. 1-3, etc.) In the closed position, the top 112 provides a wall of the body 106 that protects the mobile platforms 104 and/or seals the interior compartment 108 during transport, storage, and/or the like. For example, the closed position of the top 112 may provide tip-over protection, camouflage, environmental protection (e.g., from dust, dirt, water, sand, debris, etc.), and/or the like.

The top 112 is configured to retract to expose the interior compartment 108 of the shipping container 102 for launch activities. For example, in the open position, the at least a portion of the top 112 provides an opening that opens the interior compartment 108 of the shipping container. The stack(s) 110 of mobile platforms 104 are configured to be launched (e.g., deployed, etc.) directly from the shipping container 102. In other words, each mobile platform 104 is configured to be launched directly from the corresponding stack 110 and directly from the interior compartment 108 of the shipping container 102. The mobile platforms 104 launch directly from the interior compartment 108 of the shipping container 102 by exiting the interior compartment 108 through the opening provided by the open position of the top 112. In some examples, one or more mobile platforms 104 launches directly from the interior compartment 108 of the shipping container 102 by moving (e.g., exiting, leaving, flying, etc.), under its own power, through the opening provided by the open position of the top 112 of the shipping container 102. For example, in an exemplary implementation wherein the mobile platforms 104 are UAVs, the mobile platforms 104 may launch directly from the shipping container 102 by flying through the open top 112 under their own power. In some examples, direct launch of a mobile platform 104 from the shipping container 102 is assisted by facilitating (e.g., initiating, boosting, replacing, propelling, etc.) the acceleration of the mobile platform 104 off the corresponding stack 110 and through the open top 112, for example by spring loading the mobile platforms 104, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 104 is removed from the corresponding stack 110 before being deployed, for example manually, automatically, autonomously, and/or the like.

In some examples, the mobile platforms 104 are held within the interior compartment 108 of the shipping container 102 for storage and/or transport of the mobile platforms 104. For example, the stack(s) 110 of the mobile platforms 104 may be stored using the shipping container 102 (e.g., within a building or other structure, within a cave and/or other underground area, outside, etc.) for later use. In another example, the transport container assembly 100 is loaded onto another mobile platform (e.g., a vehicle, a semi-trailer, a marine vessel, a train, an aircraft, a mothership, etc.) and transported to another location, for example for deployment of one or more of the mobile platforms 104 from the shipping container 102 at the other location.

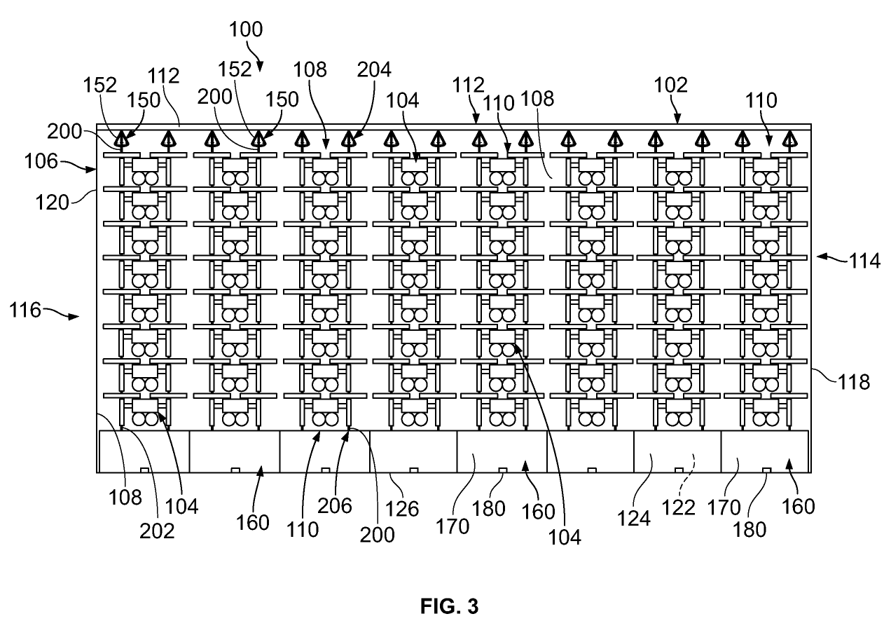

Although eight are shown in FIG. 3, each stack 110 of the mobile platforms 104 may include any number of mobile platforms 104. Moreover, although thirty-two stacks 110 are shown in FIG. 4, the interior compartment 108 of the shipping container 102 may hold any number of stacks 110 of mobile platforms 104. In one example, a 1 TEU container 102 holds thirty-two stacks 110 of eight mobile platforms 104 each, for a total of two-hundred-fifty-six mobile platforms 104. In another example, a 1 TEU container 102 holds thirty-two stacks 110 of nine mobile platforms 104 each, for a total of two-hundred-eighty-eight mobile platforms 104. In another example, a 1 TEU container 102 holds twenty-eight stacks 110 of nine mobile platforms 104 each, for a total of two-hundred-fifty-two mobile platforms 104. In another example, a 1 TEU container 102 holds twenty-eight stacks 110 of eight mobile platforms 104 each, for a total of two-hundred-twenty-four mobile platforms 104.

The pattern of stacks 110 within the interior compartment 108 that is shown herein is exemplary only. The stacks 110 of mobile platforms 104 may additionally or alternatively be arranged in any other pattern (e.g., shape, arrangement, number of rows, number of columns, etc.) within the interior compartment 108. In an exemplary implementation, the stacks 110 are oriented approximately vertical within the interior compartment 108. In other implementations, one or more stacks 110 of mobile platforms 104 extends at an approximate oblique angle within the interior compartment 108. In addition or alternatively to the top 112 being openable, at least a portion of one or more of the end walls 118 and/or 120, the side walls 122 and/or 124, and/or the bottom wall 126 may be configured to open to enable the mobile platforms 104 to launch directly from the interior compartment 108 of the shipping container 102.

In some examples, the transport container assembly 100 includes two or more different types of mobile platforms 104 and/or two or more mobile platforms 104 that perform different functions. For example, the transport container assembly 100 may include one or more rotorcraft and one or more fixed-wing aircraft within the shipping container 102. In an example of different functions, the transport container assembly 100 may include mobile platforms 104 that perform different tasks such as, but not limited to: communication relay; intelligence, surveillance, and reconnaissance (ISR); effector; a special purpose function; and/or the like. In some examples, the mobile platforms 104 are organized, arranged, and/or the like (e.g., in an order, etc.) based on the functionalities performed by the mobile platforms 104. In this way, the mobile platforms 104 can be launched from the shipping container 102 in an order based on the various functions of the mobile platforms 104. For example, the mobile platforms 104 that are desired to be launched first may be organized at the top 112. In one example, mobile platforms 104 with special tasks and/or ISR mobile platforms 104 may be arranged to be the first out of the shipping container 102. Optionally, the mobile platforms 104 are launched from the shipping container 102 in a checkerboard pattern.

Some examples include hierarchical standards for loading, unloading, and/or launching the mobile platforms 104. For example, a group of mobile platforms 104 configured to perform a corresponding operation and/or mission may be packaged onto a corresponding pallet and loaded into the ISO shipping container 102 for deployment of the operation and/or mission from the ISO shipping container 102. In some examples, two or more pallets containing mobile platforms 104 dedicated to one or more different operations and/or missions may be loaded into the ISO shipping container 102, for example to provide the capability of launching two or more missions directly from the ISO shipping container 102. Similarly, two or more ISO containers 102 can be networked together. For example, a container vehicle (e.g., trains, ships, motor vehicles, aircrafts, etc.) may be loaded with two or more of the ISO shipping containers 102 (e.g., as shown in FIG. 1, etc.) to enable the deployment of one or more independent and/or coordinated missions that may be performed by any number of container vehicles deployed by any number, combination, arrangement, and/or the like of the carried ISO shipping containers 102.

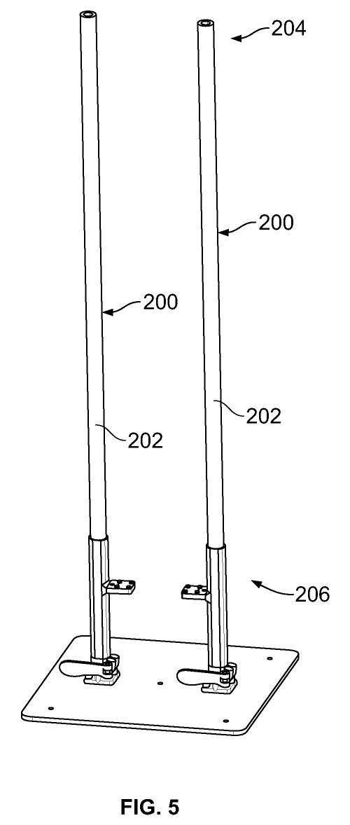

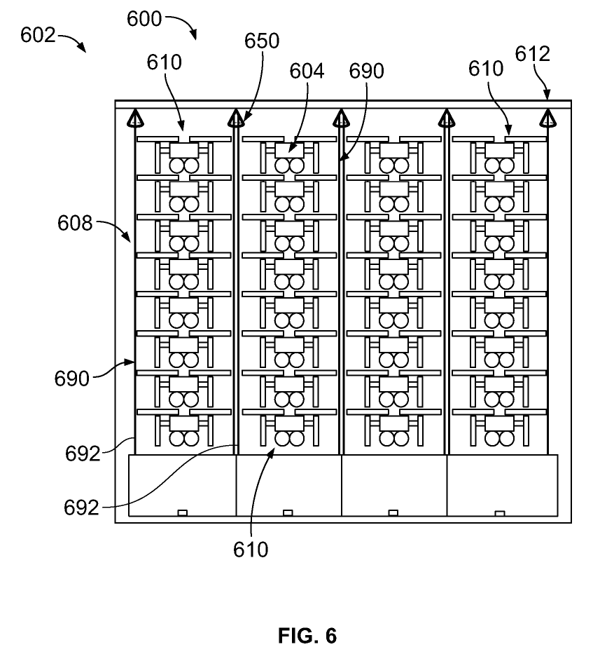

In some examples, the container 102 and/or the stacks 110 of the mobile platforms 104 includes one or more launch elements (e.g., the launch elements 200 shown in FIGS. 3 and 5, the launch elements 690 shown in FIG. 6, etc.) that extend within the interior compartment 108 and are configured to: hold the stacks 110 of mobile platforms thereon, guide the mobile platforms 104 during launch thereof from the shipping container 102, to hold the mobile platforms 104 in alignment within the corresponding stack 110, and/or the like. The launch elements may include any type, structure, geometry, mechanism, and/or the like, such as, but not limited to, a rail, a rod, a support, a bracket, a tube, a fin, and/or the like. In some examples, the launch elements include approximately vertical launch elements; in addition or alternatively, one or more of the launch elements extends approximately horizontally and/or at an oblique angle.

In some examples, the launch elements are integrated into the shipping container 102, for example in a manner that facilitates efficient and controlled deployment. For example, launch elements may be affixed along the interior walls and/or floor of the shipping container 102, for example positioned parallel to each other on opposite sides. This configuration supports vertical stacking of the mobile platforms, allowing for efficient use of available space. In some examples, the positioning of the launch elements may correspond to the layout of the tubes designed for rotorcraft, for example enabling a more seamless interaction between storage and launch functions of the shipping container 102. In some examples, the launch elements are fabricated from relatively lightweight, durable materials such as aluminum and/or composite materials to uphold structural integrity while minimizing additional weight imposed on the shipping container 102. Optionally, the design of the launch elements includes a U-shaped cross-section, for example to ensure the smooth sliding of the mobile platforms 104 along the guide paths without obstruction.

Optionally, adjustable mounting points are provided for the launch elements, for example facilitating more precise alignment and/or spacing tailored to specific mobile platform sizes and/or configurations. Such an approach allows for reconfiguration based on the dimensions and deployment requirements of various mobile platform payloads. In some examples, a locking and release mechanism is incorporated into the launch elements, for example enabling more secure retention of mobile platform stacks 110 during transport and/or better controlled release during deployment of the mobile platforms 104. The locking and release mechanism may be electronically and/or pneumatically actuated, potentially integrating with remote and/or automated systems. Optionally, for example to assist with alignment during loading, the launch elements may be equipped with assistive features such as alignment guide pins and/or tapered sections at entry points. These assistive features would streamline the insertion and retrieval of mobile platform stacks 110 from the launch elements, for example providing more efficient loading and unloading processes and reducing manual handling maneuvers.

In an example implementation of the launch elements 200 shown in FIGS. 3 and 5, the launch elements 200 include guide rods 202 that extend within the interior compartment 108 and are configured to hold (e.g., secure, contain, etc.) corresponding stacks 110 of the mobile platforms 104. The guide rods 202 extend lengths (e.g., along the height of the shipping container 102, etc.) from bases 206 of the guide rods 202 to end portions 204 of the guide rods 202. As shown herein, in an example implementation, the length of each of the guide rods 202 extends approximately vertically within the interior compartment 108 (e.g., when the body 106 of the shipping container 102 is oriented as shown in FIGS. 1-3 with the bottom wall 126 facing downward, etc.). However, in addition or alternatively, the length of one or more of the guide rods 202 extends within the interior compartment 108 approximately horizontally and/or at an oblique angle. In some examples, the guide rods 202 are arranged within the interior compartment 108 in a framework that enables simultaneous and/or sequential launch of the mobile platforms 104. Optionally, the guide rods 202 are configured to hold corresponding stacks 110 of rotorcraft. Although shown with two guide rods 202 holding a single stack 110 of the mobile platforms 104, a stack 110 of the mobile platforms 104 may be held by any number of the launch elements 200 (e.g., a single guide rod 202 holding a stack 110, etc.)

Another example implementation of the launch elements is shown in FIG. 6. For example, a transport container assembly 600 includes launch elements 690 that include tubes 692 that hold (e.g., contain, etc.) corresponding stacks 610 of mobile platforms 604. The tubes 692 extend within an interior compartment 608 of the shipping container 602 with lengths of the tubes 692 extending along the height of the shipping container 602. In an example implementation, the length of each of the tubes 692 extends approximately vertically within the interior compartment 608, for example when the shipping container 602 is oriented as shown in FIG. 6. However, in addition or alternatively, the length of one or more of the tubes 692 extends within the interior compartment 608 approximately horizontally and/or at an oblique angle. In some examples, the tubes 692 are configured to hold corresponding stacks 610 of rotorcraft. In some examples, the tubes 692 are arranged within the interior compartment 608 in a framework that enables simultaneous and/or sequential launch of the mobile platforms 604. As shown in FIG. 6, the transport container assembly 600 includes securing mechanisms 650 that are operatively connected between a top 612 of the shipping container 602 and the launch elements 690 such that the securing mechanism 650 is configured to receive a corresponding launch element 690 therein when the top 612 is in the closed position (e.g., as shown in FIG. 6, etc.).

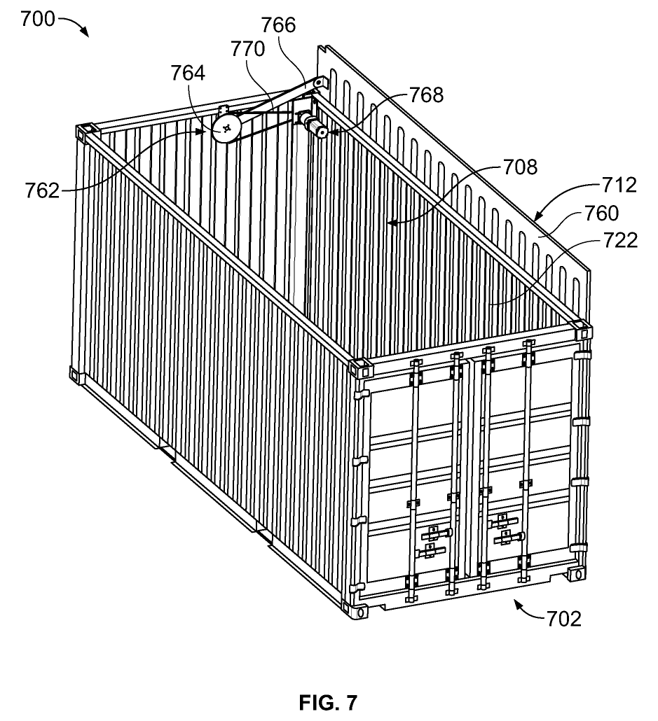

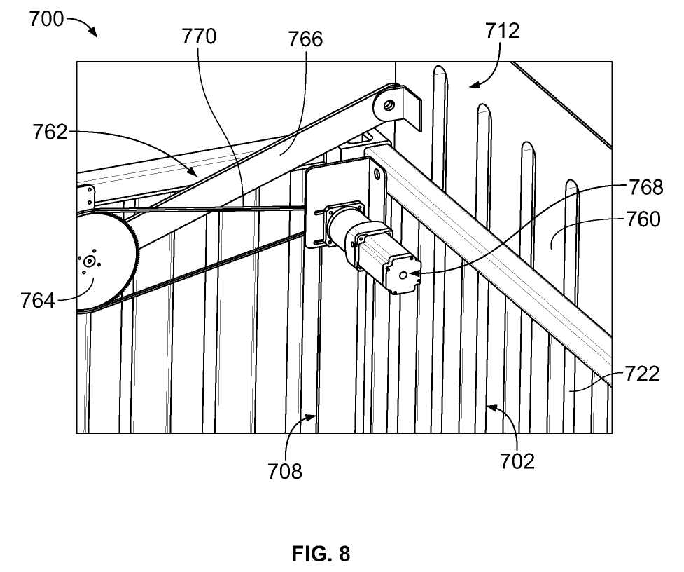

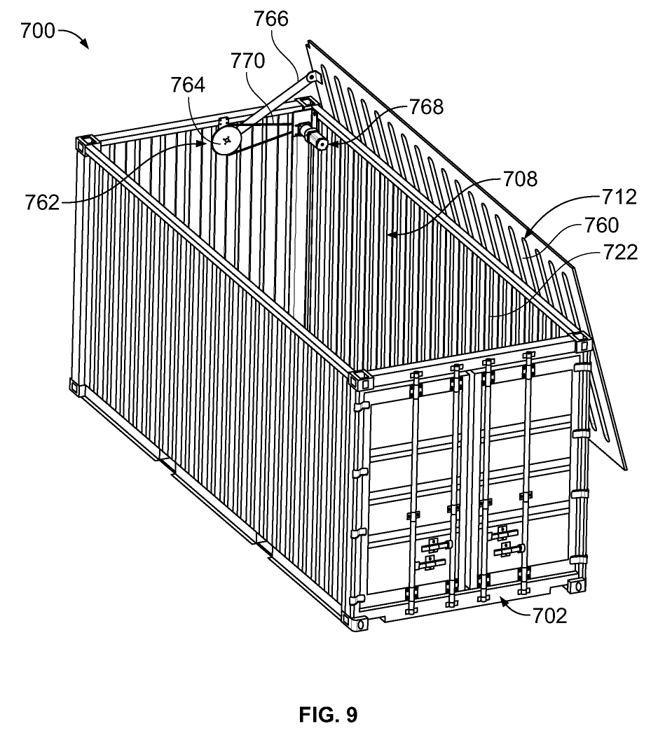

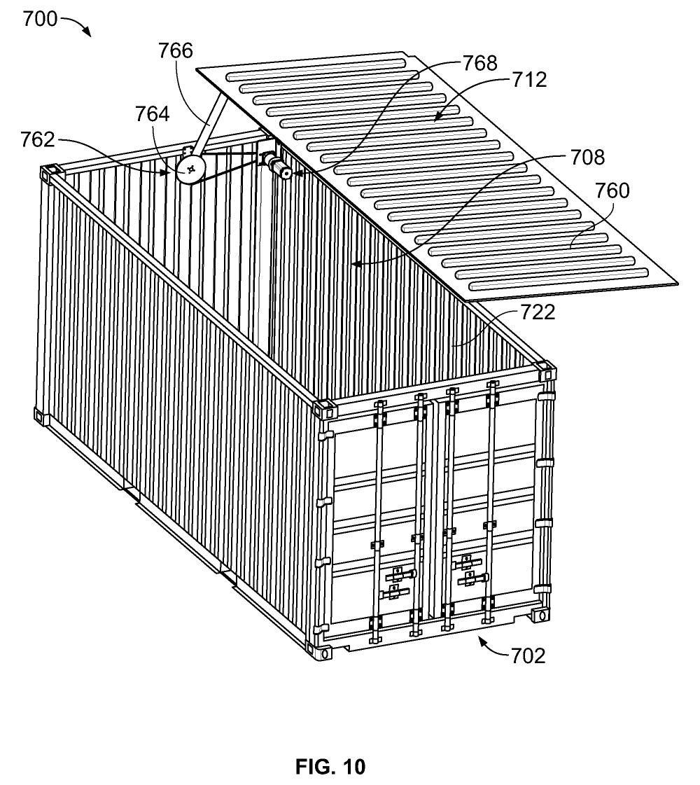

Referring again to FIGS. 1-5, the top 112 of the shipping container 102 is moveable between the open position and the closed position using any method, mechanism, structure, means, geometry, type, and/or the like that enables the top 112 to function as described and/or illustrated herein. In some examples, the top 112 of the shipping container 102 includes a door that provides the opening through which the mobile platforms 104 exit the interior compartment 108. For example, the top 112 may include a panel door (e.g., a single panel door, a multi-panel sectional door, etc.) that is configured to move to the open position by moving down along the side walls 122 and/or 124 and/or the end walls 118 and/or 120 of the shipping container 102 (e.g., the top 712 shown in FIGS. 7-11, etc.). Some examples of the top 112 include a roller door that is configured to wind up (e.g., around a spool, etc.) to retract to the open position and unwind (e.g., wind out, unspool, etc.) to extend to the closed position. Examples of other types of doors that may be additionally or alternatively included by the top 112 include, but are not limited to, hinged doors, flexible sheets, explosive panels, sectional doors, clamshell arrangements (e.g., twin door panels that are hinged to open away from each other, etc.), and/or the like. In one example of a hinged door, one or more sections of the top 112 are hinged to lift upward (e.g., the top 712 shown in FIGS. 7-11, etc.). In some examples, providing the top 112 with a clamshell arrangement enables the top 112 to open more fully to increase the size of the opening of the top 112 in the open position. The top 112 may include any type of hardware, structure, mechanism, means, and/or the like that enables the top 112 to function as described and/or illustrated herein, for example jamb type hardware, track type hardware, tracks, rails, rods, hinges, rollers, springs, torsion springs, extension springs, counterbalances, lift mechanisms, electrical motors, gravity assist devices, shocks, damping mechanisms, pulleys, wheels, gears, hubs, chains, cables, belts, arms, shafts, and/or the like.

The configuration of the top 112 to enable the top 112 to move between the open and closed positions may be selected to reduce the time of transitioning from transport to launch mode, for example enhancing operational efficiency. In contrast to existing fixed-roof designs of ISO shipping containers, the openable top 112 facilitates expedited access and deployment, for example reducing deployment preparation time and enhancing operational readiness.

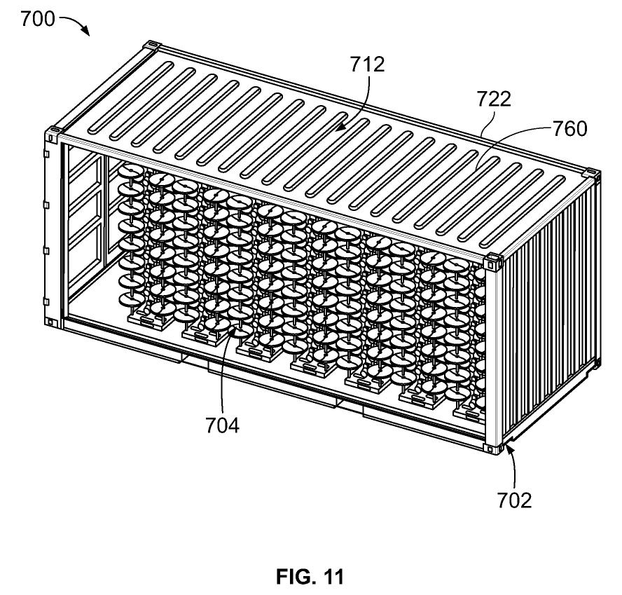

In one example of the top 112, a transport container assembly 700 includes a top 712 that includes a panel door configuration according to an exemplary implementation. In the example of FIGS. 7-11, a shipping container 702 includes the top 712, which includes a panel door 760 that is configured to open by moving down along a side wall 722 of the shipping container 702. An example implementation of the top 712 includes a pulley 762 that includes a wheel 764 and an arm 766. One end of the arm 766 is connected to the wheel 764 and the other end of the arm 766 is connected to the panel door 760. Rotation of the wheel 764 is driven by an electric motor 768 connected to the wheel 764 by chain, cable and/or belt 770 in an example implementation, but other arrangements may additionally or alternatively be used. The pulley 762 enables the panel door 760 to move down and along and to move upward and away from the side wall 722 of the shipping container 702. For example, rotation of the wheel 764 is configured to rotate the arm 766 to move the panel door 760 between the open position shown in FIG. 7 and the closed position shown in FIG. 11. To close the top 712 of the shipping container 702, the pulley 762 is configured to move the panel door 760 up along the top 712 of the shipping container 702 from the open position shown in FIG. 7 to the closed position shown in FIG. 11. To open the top 712, the pulley 762 is configured to move the panel door 760 down along the side wall 722 of the shipping container 702 from the closed position shown in FIG. 11 to the open position shown in FIG. 7. As shown in FIG. 7, the panel door 760 extends along the side wall 722 in the open position. Movement of the panel door 760 from the closed position to the open position opens an interior compartment 708 of the shipping container 702 to thereby enable mobile platforms 704 (not shown in FIGS. 7-10) to launch directly from the interior compartment 708 of the shipping container 702.

Referring again to FIG. 3, the transport container assembly 100 includes securing mechanisms 150 that are operatively connected between the top 112 and the launch elements 200. For example, each securing mechanism 150 is mounted to an interior side of the top 112 and includes a concave segment 152 that is configured to receive an end portion 204 of a corresponding launch element 200 therein when the top 112 is in the closed position. The concave segment 152 of each securing mechanism 150 is configured to limit a range of movement of the end portion 204 of the launch element 200 when the top 112 is in the closed position. For example, the securing mechanisms 150 function as containment systems that provide physical boundaries to control movement of the end portions 204 of the launch elements 200, for example during transport, shipping, handling, and/or the like of the transport container assembly 100. For example, when dynamic forces cause an end portion 204 of a launch element 200 to move (e.g., tip, wobble, rotate, vibrate, translate, move back and forth, move from bending of the launch element 200 along the length of the launch element 200, etc.), the concave segment 152 of the securing mechanism 150 includes converging surfaces that guide and constrain the corresponding end portion 204, for example within defined movement parameters, and thereby limit (e.g., reduce, prevent, etc.) displacement (e.g., lateral, etc.) of the end portion 204 that may be sufficient to lead to structural damage, misalignment, and/or the like.

In some examples, during bending and/or flexing of the launch elements 200 caused by container movement, loading operations, transit forces and/or vibrations, and/or the like, the geometries (e.g., funnel-shaped tapered configurations, etc.) of the concave segments 152 of the securing mechanisms 150 provide progressive containment that accommodates controlled movement of the end portions 204 while establishing limits to prevent overextension. For example, the geometry of one or more of the concave segments 152 incorporates one or more angled surfaces that creates a guidance system for the end portions 204 of the launch elements 200, where the narrowing geometry provides increasing constraint as movement approaches critical limits. This configuration enables the securing mechanism 150 to accommodate (e.g., normal, etc.) operational movement while preventing an amount of displacement that could result in warping, collision between components, structural failure, and/or the like, for example during the dynamic conditions experienced throughout the transit, shipping, and handling process. In some examples, the geometry of the concave segments 152 allows for (e.g., accommodates, enables, etc.) natural flexural motion of the launch elements 200 while maintaining the end portions 204 within acceptable operational boundaries, thereby reducing stress concentrations that could compromise the integrity of the launch elements 200.

The securing mechanisms 150 may be implemented in various configurations, geometries, and/or the like on the top 112. Although each of the concave segments 152 of the securing mechanisms 150 may include any geometry (e.g., size, shape, etc.), in some examples one or more of the concave segments 152 includes a funnel shape, a flared shape, a fluted shape, a conical shape, a frustoconical shape, a venturi tube, a circular cross-sectional shape, an elliptical cross-sectional shape, a rectangular cross-sectional shape, a polygonal cross-sectional shape, a geometry based on and/or complementary with a geometry of the end portion 204 of the corresponding launch element 200 (e.g., to accommodate various configurations of the end portions 204, etc.), and/or the like. In some examples, one or more concave segments 152 includes a different geometry as compared to one or more other concave segments 152, for example based on the geometry of the corresponding launch element 200. The concave segments 152 of the securing mechanisms 150 may incorporate any taper angle, for example ranging from gradual slopes to steep converging surfaces, and for example depending on the specific containment requirements, dimensions, and/or the like of the launch elements 200.

In some examples, the transport container assembly 100 includes multiple securing mechanisms 150 arranged in different patterns across the interior side of the top 112. Optionally, individual securing mechanisms 150 are positioned to correspond with each launch element 200 (e.g., each concave segment 152 receives a single launch element 200 therein, etc.), while in other configurations, one or more concave segments 152 is configured to receive two or more launch element end portions 204 therein.

The securing mechanisms 150 may be arranged in any pattern along the top 112, such as, but not limited to, linear arrays, grid patterns, clustered configurations, a configuration based on the layout of launch elements 200 within the shipping container 102, and/or the like. For example, the securing mechanisms 150 may be positioned at various locations on the interior side of the top 112, including but not limited to, centrally located positions, offset arrangements toward specific top areas, distributed patterns that correspond to the configuration of the launch elements 200, and/or the like. In some examples, the securing mechanisms 150 are integrated directly into the structure of the top 112, while in other implementations, the securing mechanisms 150 are implemented as removable and/or adjustable components that can be repositioned based on different launch element configurations and/or transport requirements. In some examples, one or more of the securing mechanisms 150 is fixedly mounted to the top 112. In some examples, one or more of the securing mechanisms 150 is mounted to the top 112 such that at least the concave segment 152 is free to move within a play relative to the top 112.

The depth, opening dimensions, and/or the like of the concave segments 152 of the securing mechanisms 150 may vary, in some examples, to accommodate different launch element geometries and/or movement ranges. For example, some implementations may include one or more securing mechanisms 150 that feature a shallower concave segment 152 with a wider opening for applications requiring less (e.g., minimal, etc.) constraint. Moreover, and for example, some implementations may include one or more securing mechanisms 150 that include deeper concave segments 152 with narrower openings for applications requiring more (e.g., maximum, etc.) containment. In some examples, one or more walls of one or more of the concave segments 152 incorporates a surface texture, coating, and/or the like, for example to provide improved interaction characteristics with the end portion(s) 204 of the corresponding launch element(s) 200. Optionally, at least a portion of the concave segment 152 of one or more of the securing mechanisms 150 is flexible and/or resilient, for example to provide improved interaction characteristics with the end portion(s) 204 of the corresponding launch element(s) 200. In some examples, the concave segment 152 of one or more of the securing mechanisms 150 includes a cushion, for example to provide improved interaction characteristics with the end portion(s) 204 of the corresponding launch element(s) 200.

In some examples, the concave segments 152 of the securing mechanisms 150 are configured to receive the end portions 204 of the corresponding launch elements 200 therein as the top 112 is moved to the closed position. For example, movement of the top 112 from the open position to the closed position is configured to move the concave segments 152 of the securing mechanisms 150 over the end portions 204 of the launch elements 200 such that the end portions 204 are received into the concave segments 152.

For example, when the top 112 is closed, the concave segments 152 of the securing mechanisms 150 engage with the end portions 204 of the launch elements 200 through a progressive containment process that facilitates positioning, alignment, and a desired (e.g., relatively secure, etc.) fit. As the top 112 moves toward its closed position, the concave segments 152 of the securing mechanisms 150 may guide the end portions 204 into their designated containment zones, for example through the tapered geometry of the concave segments 152. The converging surfaces of the concave segments 152 may provide initial contact with the end portions 204 at the wider opening sections, creating alignment guidance that directs the end portions 204 toward the narrower containment areas as the closure of the top 112 progresses. In some examples, the engagement process is facilitated by angled surfaces of the concave segments 152 of the securing mechanisms 150, for example which create progressive constraint as the end portions 204 of the launch elements 200 move deeper into the concave segments 152 during closure of the top 112. In some examples, tapered configurations of the concave segments 152 enables initial positioning tolerance while providing increasing guidance and constraint as the engagement deepens. Optionally, the walls of the concave segments 152 establish contact with the end portions 204 at multiple points, for example creating a distributed engagement pattern that ensures desired fit and prevents misalignment during the closure sequence.

The desired engagement may be achieved through the geometric relationship between the concave segments 152 of the securing mechanisms 150 and the profiles of the end portions 204 of the launch elements 200, for example where the dimensions of the concave segments 152 correspond to the launch element configurations to provide appropriate clearances and contact surfaces. In some examples, the geometry of one or more of the concave segments 152 accommodates the natural positioning variations of the end portion 204 of the corresponding launch element(s) 200 while ensuring that final engagement positions maintain the end portions 204 within acceptable operational boundaries. The progressive containment features of the design of the concave segments 152 may enable self-correcting alignment as the top 112 closes, for example where positioning discrepancies are automatically adjusted through the guidance provided by the converging surfaces of the concave segments 152.

In some examples, the fit between the concave segments 152 of the securing mechanisms 150 and the end portions 204 of the launch elements 200 tips may be facilitated through the dimensional relationships established during the engagement process, for example where the opening sizes and taper angles of the concave segments 152 correspond to the dimensions and movement requirements of the end portions 204. In some examples, the concave segments 152 of the securing mechanisms 150 provide sufficient clearance to accommodate thermal expansion, manufacturing tolerances, operational movement, and/or the like while maintaining positive engagement that limits excessive displacement. Optionally, the engagement between the concave segments 152 and the end portions 204 incorporates features that distribute contact forces across the surfaces of the end portions 204, for example reducing stress concentrations and ensuring structural integrity.

Referring now to FIGS. 3 and 4, the transport container assembly 100 includes alignment mechanisms 160 operatively connected between the body 106 of the shipping container 102 and the launch elements 200 such that the alignment mechanisms 160 hold the launch elements 200 within the interior compartment 108 of the shipping container 102 in fixed positions relative to each other. For example, the alignment mechanisms 160 may be configured to hold the bases 206 of adjacent launch elements 200 apart by a predetermined distance. In some examples, the alignment mechanisms 160 provide a dedicated framework to support mobile platform storage and/or deployment arrangements. The alignment mechanisms 160 may include any structure, such as, but not limited to, a pallet, a floor grid, a rail system, a rail, a rack, a palletized rack, and/or the like. For example, the alignment mechanisms 160 may include pallets (e.g., the pallets 170 shown in FIGS. 3 and 4, etc.) that are configured to interlock with each other, for example interlocking together into a grid of the pallets. In some examples, the alignment mechanisms 160 include rails (e.g., the rails 180 shown in FIGS. 3 and 4, etc.) that directly hold or indirectly hold (e.g., by holding a pallet that holds one or more stacks 110, etc.) one or more of the launch elements 200. In some examples wherein the alignment mechanisms 160 include one or more rails, the launch elements 200 (with or without a stack 110) are configured to be loaded into the interior compartment 108 of the shipping container 102 by sliding the launch elements 200 (or a structure, such as a pallet, that holds the launch elements 200) along the rails. In some examples wherein the alignment mechanisms 160 include one or more rails, one or more of the rails may be configured to interlock with one or more of the launch elements 200 (or a structure, such as a pallet, that holds the launch elements 200) at a location along a length of the rail.

In an example of the alignment mechanisms 160 including a palletized rack, a modular insert system could be provided within the shipping container 102, for example where launch elements 200 (with or without a stack 110 of the mobile platforms 104) are preloaded onto removable palletized racks that facilitate easier transfer of the launch elements 200 and stacks 110 of mobile platforms 104 in and out of the shipping container 102 (e.g., using forklifts, etc.), for example improving turnaround and reloading times.

In some examples wherein the alignment mechanisms 160 include a floor grid, the floor grid may be configured to contain a power supply (e.g., batteries, cabling, etc.) and/or other components. In some examples, an automated loading system is provided, for example featuring conveyor mechanisms and/or robotic arms that place alignment mechanisms 160, launch elements 200, and/or stacks 110 of the mobile platforms into launch positions within the shipping container 102. This automation reduces manual handling, for example decreasing the risk of damage and improving loading precision.

In an example implementation shown in FIGS. 3 and 4, the alignment mechanisms 160 include the pallets 170 and the rails 180. The pallets 170 are configured to interlock with each other with a puzzle-piece design into a grid of the pallets 170. Although each pallet 170 is shown in FIGS. 3 and 4 as holding two launch elements 200 and a single mobile platform stack 110, each pallet 170 may be configured to hold any number of launch elements 200 and any number of stacks 110 of the mobile platforms 104. The rails 180 are configured to directly hold one or more corresponding pallets 170. The rails 180 provide a loading structure that enables the pallets 170 to be loaded into and out of the interior compartment 108 of the shipping container 102. For example, the pallets 170 are configured to be loaded into the interior compartment 108 of the shipping container 102 by sliding the pallets 170 along the rails 180 into the corresponding position within the interior compartment 108. In an example implementation, the pallets 170 are configured to interlock with the rails 180 at corresponding locations along the lengths of the rails 180 to hold the pallets 170 in the corresponding positions within the interior compartment 108. In some examples, the pallets 170 and the rails 180 provide a modular insert system wherein the mobile platforms 104 are preloaded onto the pallets 170 and the preloaded pallets 170 are loaded into the shipping container 102 (e.g., using forklifts, etc.) for later deployment, which for example may improve turnaround and reloading times.

In some examples, the pallets 170 incorporate complementary geometric features that facilitate systematic loading procedures within the shipping container 102. For example, during loading operations, the pallets 170 may engage through interlocking configurations that guide each pallet 170 into a predetermined position, for example reducing placement inconsistencies and improving loading efficiency. The puzzle-piece design of the pallets 170, in some examples, provides visual and tactile feedback to loading personnel, for example enabling more accurate and more consistent positioning of the launch elements 200 and/or the mobile platforms 104 through the geometric constraints inherent in the pallet interface.

Optionally, the pallets 170 include stabilization features that, for example, function through mechanical interlocking that reduces or prevents lateral displacement, for example during transit, shipping, and/or handling operations. In some examples, when the pallets 170 are positioned together, complementary shapes of the pallets 170 create physical barriers that resist movement caused by container tilting, loading forces, handling forces, vibrations, and/or the like. Optionally, interlocking edges of the pallets 170 distribute loads across multiple pallet interfaces, reducing stress concentrations on individual components and enhancing overall system stability, for example during transit, shipping, and/or handling operations.

The alignment capabilities of the pallets 170 may be achieved through the geometric constraints of the interlocking design, wherein the complementary shapes guide the pallets 170 into specific orientations relative to each other and the container structure. In some examples, the puzzle-piece configuration of the pallets 170 establishes reference points that maintain consistent spacing and positioning of launch elements 200 and mobile platforms 104 throughout the transport process. Optionally, the interlocking features provide self-correcting alignment properties, wherein positioning errors are automatically corrected as pallets 170 engage with adjacent components (e.g., other pallets 170, the rails 180, etc.) during the loading sequence.

In some examples, the rails 180 facilitate loading operations by providing structured pathways that guide the positioning of the pallets 170 (and thereby the launch elements 200 and mobile platforms 104) within the shipping container 102. During loading procedures, the rails 180 may serve as reference frameworks that establish predetermined placement zones, for enabling loading personnel to systematically position equipment according to the rail configuration. The rails 180 provide physical guides that direct the movement of components during the loading sequence, for example reducing the potential for improper placement and improving overall loading efficiency through the organized arrangement within the container space.

In some examples, the rails 180 contribute to alignment by establishing fixed reference points that maintain consistent positioning relationships between system components throughout transport and deployment operations. For example, the rails 180 may provide geometric constraints that guide components into specific orientations relative to the container structure and each other. During alignment procedures, the rails 180 may serve as positioning frameworks that facilitate proper spacing and angular relationships between components, wherein the rail configuration creates alignment references that facilitate more precise positioning when the system is deployed at destination locations.

Optionally, the rails 180 provide stabilization through their structural configuration that distributes loads and constrains movement, for example during transit and/or handling operations. The rails 180 may function as stabilizing frameworks that resist lateral displacement and limit movement of system components when subjected to dynamic forces, for example encountered during shipping and handling. In some examples, the rails 180 contribute to overall system stability by creating interconnected structural networks that transfer loads between components, reducing stress concentrations on individual elements and maintaining structural integrity, for example throughout the transport process. In some examples, the configuration of the rails 180 provides mechanical stability that reduces warping and deformation of system components during container movement, loading operations, handling forces (e.g., vibrations, etc.), and/or the like.

The transport container assembly 100 may be configured to accommodate temperature variations through thermal expansion and contraction management features integrated into the securing mechanisms 150 and/or the alignment mechanisms 160. For example, during temperature fluctuations encountered in shipping environments, the launch elements 200 may experience dimensional changes that could affect their positioning within the container 102. In some examples, the securing mechanisms 150 incorporate thermal compensation features that allow for controlled expansion and contraction of the launch elements 200 while maintaining their secured position within the container space.

In some examples, the securing mechanisms 150 provide thermal accommodation through tapered geometry that enables dimensional changes in the end portions 204 during temperature variations. As the launch elements 200 expand or contract due to temperature changes, the concave segments 152 of the securing mechanisms 150 may accommodate these dimensional variations while continuing to provide guidance and constraint for the end portions 204. The progressive containment features of the concave segments 152 may allow for thermal movement while preventing displacement that could compromise the securing function.

In some examples, the pallets 170 of the alignment mechanisms 160 incorporate thermal expansion joints, flexible interfaces, and/or the like that accommodate dimensional changes in the structures of the pallets 170 and the launch elements 200 during temperature variations. Optionally, the interlocking features of the pallets 170 are designed with clearances that allow for thermal movement while maintaining the mechanical engagement necessary for stabilization and alignment functions. The complementary geometric features may include, but are not limited to, thermal compensation zones that provide space for expansion and contraction without compromising the interlocking capabilities of the pallets 170.

In some examples, the alignment mechanisms 160 include thermal compensation features that maintain proper positioning relationships between the launch elements 200 and the top 112 despite temperature-induced dimensional changes. The alignment mechanisms 160 may incorporate adjustable elements, flexible connections, and/or the like that accommodate thermal expansion and contraction while preserving the alignment function. In some examples, the alignment mechanisms 160 include temperature-responsive components that automatically adjust to maintain proper positioning as thermal conditions change throughout the transport process.

In some examples, the securing mechanisms 150 incorporate thermal management features that accommodate dimensional changes in both the container structure and launch elements 200 during temperature variations. The securing mechanisms 150 may include flexible connections, adjustable elements, and/or the like that allow for thermal movement while maintaining the control and constraint functions necessary to reduce or prevent structural deformation. Optionally, the securing mechanisms 150 provide thermal isolation features that reduce the transmission of temperature-induced stresses between the container and rail assembly components.

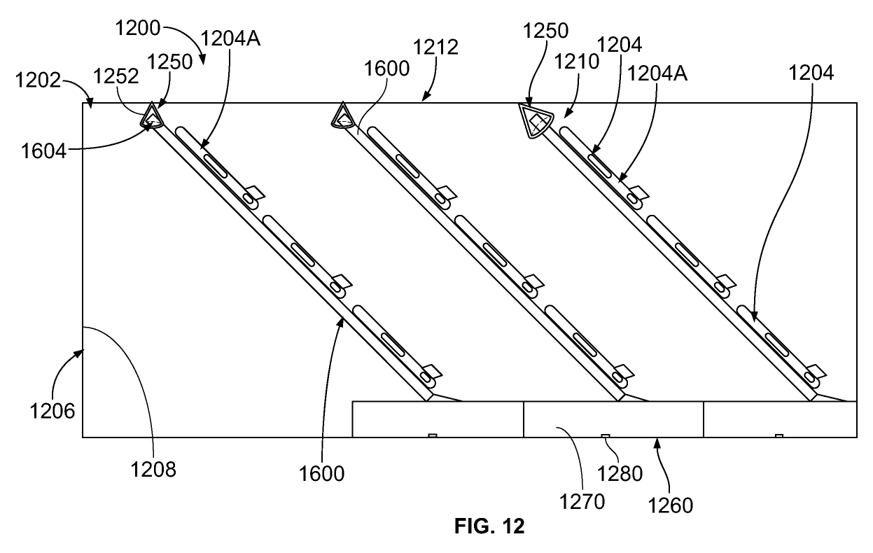

FIG. 12 illustrates a transport container assembly 1200 configured for launching mobile platforms 1204 that include fixed-wing aircraft 1204A. The transport container assembly 1200 includes a shipping container 1202 and the fixed-wing mobile platforms 1204A. The transport container 1202 includes a body 1206 that includes an interior compartment 1208 that is configured to hold one or more magazines 1210 of the mobile platforms 1204 therein. The body 1206 of the shipping container 1202 includes a top 1212 that opens to enable the mobile platforms 1204 to launch directly from the shipping container 1202 by exiting the interior compartment 1208 through the open top 1212.

In some examples, one or more of the fixed-wing mobile platforms 1204A launches directly from the interior compartment 1208 of the shipping container 1202 by flying, under its own power, through the opening provided by the open position of the top 1212 of the shipping container 1202. In addition or alternatively, direct launch of the fixed-wing mobile platforms 1204A from the shipping container 1202 is assisted by facilitating (e.g., initiating, boosting, replacing, propelling, thrusting, etc.) the acceleration of the fixed-wing mobile platforms 1204 out of the interior compartment 1208 and through the open top 1212. For example, in an example implementation of FIG. 12, the transport container assembly 1200 includes pneumatic launch elements 1600 that propel the fixed-wing mobile platforms 1204A out of the interior compartment 1208 through the open top 1212. The pneumatic launch elements 1600 guide the fixed-wing mobile platforms 1204A during launch of the mobile platforms 1204 from the ISO shipping container 1202.

Although illustrated herein with respect to rotorcraft and fixed-wing mobile platforms, as described above the disclosure is not limited thereto. In some examples, the transport container assemblies of the disclosure include ISO shipping containers that are configured to deploy UGVs directly therefrom. In one example, one or more UGVs having a payload of one or more UAVs can be contained within and directly deployed from the ISO shipping container (e.g., at the start of an operation and/or mission; through an open top, side, and/or end of the ISO shipping container; etc.). Aspects of the disclosure utilizing UGVs may provide the technical effect of extending the range of UAVs, for example because UGVs are less weight-limited (as compared to UAVs) and can therefore carry larger and more capable energy systems (e.g., motors, batteries, fuel, solar, etc.).

The transport container assembly 1200 includes securing mechanisms 1250 that are operatively connected between the top 1212 and the launch elements 1600. For example, each securing mechanism 1250 is mounted to an interior side of the top 1212 and includes a concave segment 1252 that is configured to receive an end portion 1604 of a corresponding launch element 1600 therein when the top 1212 is in the closed position. The concave segment 1252 of each securing mechanism 1250 is configured to limit a range of movement of the end portion 1604 of the launch element 1600 when the top 1212 is in the closed position.

The transport container assembly 1200 includes alignment mechanisms 1260 operatively connected between the body 1206 of the shipping container 1202 and the launch elements 1600 such that the alignment mechanisms 1260 hold the launch elements 1600 within the interior compartment 1208 of the shipping container 1202 in fixed positions relative to each other. In an example implementation of FIG. 12, the alignment mechanisms 1260 include pallets 1270 and rails 1280.

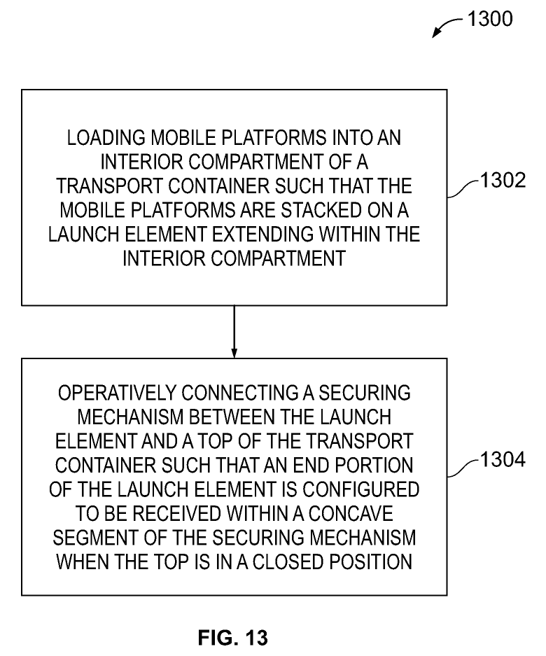

FIG. 13 is a flowchart illustrating an example of a method 1300. At 1302, the method 1300 includes loading mobile platforms into an interior compartment of a transport container such that the mobile platforms are stacked on a launch element extending within the interior compartment. At 1304, the method 1300 includes operatively connecting a securing mechanism between the launch element and a top of the transport container such that an end portion of the launch element is configured to be received within a concave segment of the securing mechanism when the top is in a closed position.

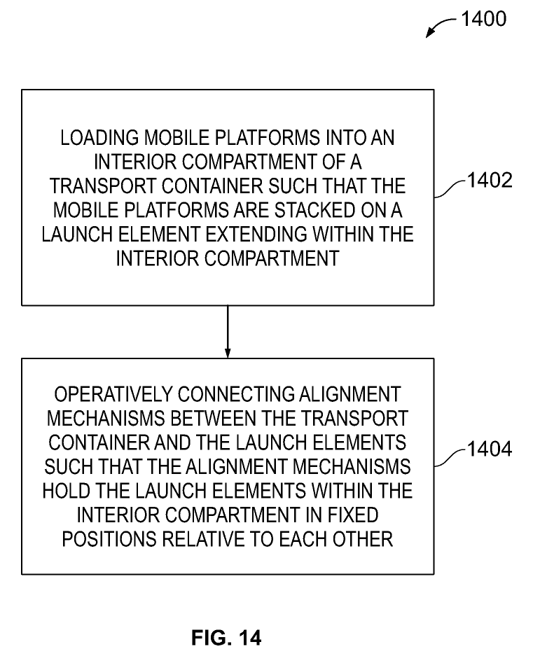

FIG. 14 is a flowchart illustrating an example of a method 1400. At 1402, the method 1400 includes loading mobile platforms into an interior compartment of a transport container such that the mobile platforms are stacked on a launch element extending within the interior compartment. At 1404, the method 1400 includes operatively connecting alignment mechanisms between the transport container and the launch elements such that alignment mechanisms hold the launch elements within the interior compartment in fixed positions relative to each other.

### Exemplary Operating Environment

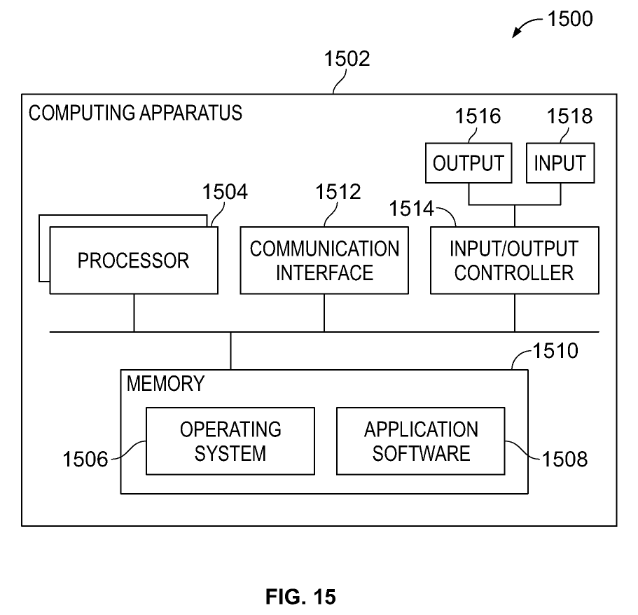

The present disclosure is operable with a computing apparatus according to an implementation as a functional block diagram 1500 in FIG. 15. In an example, components of a computing apparatus 1502 are implemented as a part of circuitry of an electronic device according to one or more implementation described in this specification. The computing apparatus 1502 comprises one or more processors 1504 which may be microprocessors, controllers, or any other suitable type of processors for processing computer executable instructions to control the operation of the electronic device. Alternatively, or in addition, the processor 1504 is any technology capable of executing logic or instructions, such as a hard-coded machine. In some examples, platform software comprising an operating system 1506 and/or any other suitable platform software is provided on the apparatus 1502 to enable application software 1508 to be executed on the device.

In some examples, the operations, actions, and/or the like of the systems disclosed herein (e.g., launching mobile platforms, etc.) is accomplished by software, hardware, firmware, and/or the like operating on a single device (e.g., a software module, a processor, a core, a firmware module, and/or the like) or distributed across multiple devices (e.g., one or more software modules, one or more processors, one or more cores, one or more firmware modules, and/or the like). For example, the systems disclosed herein may include a computer storage medium storing instructions that, when executed across two or more processors (and/or across two or more cores of one or more processors), cause the processors (and/or the cores) of the system to collectively perform the operations, actions, and/or the like of the system. For example, one processor of the system could perform one or more of the operations, actions, and/or the like of the system, while another processor could perform one or more other operations, actions, and/or the like of the system.

As used in this application, the term “circuitry” may refer to one or more or all of the following: (a) hardware-only circuit implementations (such as implementations in analog, digital, and/or quantum circuitry); (b) combinations of hardware circuit(s) and software, such as (as applicable): (i) combination of analog, digital, and/or quantum hardware circuit(s) with software/firmware, and (ii) any or all portions of hardware processor(s) (including digital and/or quantum processor(s)) with software, and memory(ies) that work together to cause an apparatus, such as a mobile device, computing device, and/or server, to perform various functions; and (c) any or all portions of hardware circuit(s), such as a microprocessor(s), processor(s), and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit and/or processor (or multiple processors) and/or portion of a hardware circuit and/or processor and its (and/or their) accompanying software and/or firmware. The term circuitry also covers, for example, and if applicable to the particular claim element, a baseband integrated circuit and/or processor integrated circuit for a mobile device and/or a similar integrated circuit in server, a cellular network device, and/or other computing and/or network device.

In some examples, computer executable instructions are provided using any computer-readable media that is accessible by the computing apparatus 1502. Computer-readable media include, for example, computer storage media and communications media. Computer storage media, such as a memory 1510, include volatile and non-volatile, removable, and non-removable media implemented in any method or technology for storage of information such as computer readable instructions, data structures, program modules, and/or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1510) is shown within the computing apparatus 1502, it will be appreciated by a person skilled in the art, that, in some examples, the storage is distributed or located remotely and accessed via a network or other communication link (e.g., using a communication interface 1512).

Further, in some examples, the computing apparatus 1502 comprises an input/output controller 1514 configured to output information to one or more output devices 1516, for example a display (e.g., displaying a GUI) or a speaker, which are separate from or integral to the electronic device. Additionally, or alternatively, the input/output controller 1514 is configured to receive and process an input from one or more input devices 1518, for example, a keyboard, a microphone, or a touchpad. In one example, the output device 1516 also acts as the input device. An example of such a device is a touch sensitive display. The input/output controller 1514 may also output data to devices other than the output device, e.g., a locally connected printing device. In some examples, a user provides input to the input device(s) 1518 and/or receives output from the output device(s) 1516.

The functionality described herein can be performed, at least in part, by one or more hardware logic components. According to an implementation, the computing apparatus 1502 is configured by the program code when executed by the processor 1504 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Examples

Aspects of the disclosure include a transport container that includes an interior compartment and a launch element extending within the interior compartment. The launch element is configured to hold a stack of mobile platforms thereon. The transport container includes a top moveable between an open position and a closed position. The open position of the top enables the mobile platforms to exit the interior compartment of the container. The transport container includes a securing mechanism operatively connected between the top and the launch element. The securing mechanism includes a concave segment configured to receive an end portion of the launch element therein when the top is in the closed position.

In some examples, the concave segment of the securing mechanism is configured to limit a range of movement of the end portion of the launch element when the top is in the closed position.

Optionally, the concave segment of the securing mechanism includes at least one of a cushion, a funnel shape, a flared shape, a fluted shape, a conical shape, a frustoconical shape, a venturi tube, a flexible portion, or a resilient portion.

Optionally, the securing mechanism is fixedly mounted to the top.

Optionally, the securing mechanism is mounted to the top such that the concave segment is free to move within a play relative to the top.

In some examples, at least one of the concave segment of the securing mechanism is configured to receive the end portion of the launch element therein as the top is moved to the closed position, or movement of the top from the open position to the closed position is configured to move the concave segment of the securing mechanism over the end portion of the launch element such that the end portion is received into the concave segment.

In some examples, the top includes at least one of a pulley, a wheel, a gear, a hub, a chain, a cable, a belt, a one piece door, a door that is configured to be automatically opened, or a panel door that is configured to open by moving down along at least one of a side wall or an end wall of the transport container.

Optionally, the launch element includes at least one of a rail, a rod, a support, a bracket, a tube, or a fin.

In some examples, the transport container includes an ISO shipping container.

In some examples, at least one of the mobile platforms includes at least one of a UAV, a rotorcraft, or a fixed wing aircraft.

Aspects of the disclosure include a transport container that includes a body having an interior compartment. The transport container includes launch elements extending within the interior compartment. The launch elements are configured to hold stacks of mobile platforms thereon. The transport container includes a top moveable between an open position and a closed position. The open position of the top enables the mobile platforms to exit the interior compartment of the container. The transport container includes alignment mechanisms operatively connected between the body and the launch elements such that the alignment mechanisms hold the launch elements within the interior compartment in fixed positions relative to each other.

Optionally, the alignment mechanisms are configured to hold bases of adjacent launch elements apart by a predetermined distance.

In some examples, the alignment mechanisms include at least one of a pallet, a rail, a floor grid, a rack, a palletized rack, pallets with at least one of the pallets being configured to interlock with at least one other pallet, pallets that interlock together into a grid of the pallets, or at least one rail that holds at least one of the launch elements.

In some examples, the alignment mechanisms include rails and the launch elements are configured to be loaded into the interior compartment by sliding along the rails.

In some examples, the alignment mechanisms include rails and at least one of the rails is configured to interlock with at least one of the launch elements at a location along a length of the rail.

Aspects of the disclosure include a method that includes loading mobile platforms into an interior compartment of a transport container such that the mobile platforms are stacked on a launch element extending within the interior compartment, operatively connecting a securing mechanism between the launch element and a top of the transport container such that an end portion of the launch element is configured to be received within a concave segment of the securing mechanism when the top is in a closed position, and operatively connecting alignment mechanisms between the transport container and the launch elements such that alignment mechanisms hold the launch elements within the interior compartment in fixed positions relative to each other.

In some examples, operatively connecting the securing mechanism between the launch element and the top includes operatively connecting the securing mechanism such that the concave segment of the securing mechanism is configured to limit a range of movement of the end portion of the launch element.

Optionally, operatively connecting the securing mechanism between the launch element and the top includes at least one of moving the top from an open position to the closed position, fixedly mounting the securing mechanism to the top, or mounting the securing mechanism to the top such that the concave segment of the securing mechanism is free to move within a play relative to the top.

Optionally, operatively connecting alignment mechanisms between the transport container and the launch elements includes at least one of interlocking at least one of the alignment mechanisms with at least one other alignment mechanism, interlocking at least one of the alignments mechanism with at least one launch element, mounting at least one launch element to at least one of the alignment mechanisms, holding bases of adjacent launch elements apart by a predetermined distance, or interlocking pallets of the alignment mechanisms together into a grid.

Optionally, the alignment mechanisms include rails and operatively connecting the alignment mechanisms between the transport container and the launch elements includes at least one of holding at least one launch element with at least one of the rails, or interlocking at least one rail with at least one of the launch elements at a location along a length of the rail.

Aspects of the disclosure include a launch system that includes a shipping container having a container roof structure. The launch system includes a plurality of launch rail assemblies positioned within the shipping container, with each launch rail assembly having a rail tip. The launch system includes securing mechanisms disposed within the shipping container and configured to prevent excessive movement of the launch rail assemblies during transit operations. The launch system includes alignment mechanisms operatively coupled between the launch rail assemblies and the container roof structure and configured to maintain proper positioning of the launch rail assemblies relative to the container roof structure. The launch system includes integrated securing mechanisms positioned between the container roof and the rail tips to control movement and prevent structural deformation. The integrated securing mechanisms are distinct from the alignment mechanisms that maintain proper positioning between the launch rail assemblies and container roof structure. The integrated securing mechanisms are operatively coupled between the container roof and the rail tips of the launch rail assemblies and configured to control movement of the launch rail assemblies and prevent structural deformation during shipping and handling operations.

Aspects of the disclosure include a method for securing launch rail assemblies during transport. The method includes positioning a plurality of launch rail assemblies within a shipping container having a container roof structure. Each launch rail assembly having a rail tip. The method includes engaging securing mechanisms disposed within the shipping container to prevent excessive movement of the launch rail assemblies during transit operations, operatively coupling alignment mechanisms between the launch rail assemblies and the container roof structure to maintain proper positioning of the launch rail assemblies relative to the container roof structure, and operatively coupling integrated securing mechanisms between the container roof and the rail tips of the launch rail assemblies to control movement of the launch rail assemblies and prevent structural deformation during shipping and handling operations.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as "first," "second," "third," etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A transport container comprising:
an interior compartment;
a launch element extending within the interior compartment, wherein the launch element is configured to hold a stack of mobile platforms thereon;
a top moveable between an open position and a closed position, wherein the open position of the top enables the mobile platforms to exit the interior compartment of the container; and
a securing mechanism operatively connected between the top and the launch element, wherein the securing mechanism comprises a concave segment configured to receive an end portion of the launch element therein when the top is in the closed position.

2. The transport container of claim 1, wherein the concave segment of the securing mechanism is configured to limit a range of movement of the end portion of the launch element when the top is in the closed position.

3. The transport container of claim 1, wherein the concave segment of the securing mechanism comprises at least one of a cushion, a funnel shape, a flared shape, a fluted shape, a conical shape, a frustoconical shape, a venturi tube, a flexible portion, or a resilient portion.

4. The transport container of claim 1, wherein the securing mechanism is fixedly mounted to the top.

5. The transport container of claim 1, wherein the securing mechanism is mounted to the top such that the concave segment is free to move within a play relative to the top.

6. The transport container of claim 1, wherein at least one of:
the concave segment of the securing mechanism is configured to receive the end portion of the launch element therein as the top is moved to the closed position; or
movement of the top from the open position to the closed position is configured to move the concave segment of the securing mechanism over the end portion of the launch element such that the end portion is received into the concave segment.

7. The transport container of claim 1, wherein the top comprises at least one of a pulley, a wheel, a gear, a hub, a chain, a cable, a belt, a one piece door, a door that is configured to be automatically opened, or a panel door that is configured to open by moving down along at least one of a side wall or an end wall of the transport container.

8. The transport container of claim 1, wherein the launch element comprises at least one of a rail, a rod, a support, a bracket, a tube, or a fin.

9. The transport container of claim 1, wherein the transport container comprises an International Organization for Standardization (ISO) shipping container.

10. The transport container of claim 1, wherein at least one of the mobile platforms comprises at least one of an uncrewed aerial vehicle (UAV), a rotorcraft, or a fixed wing aircraft.

11. A transport container comprising:
a body comprising an interior compartment;
launch elements extending within the interior compartment, wherein the launch elements are configured to hold stacks of mobile platforms thereon;
a top moveable between an open position and a closed position, wherein the open position of the top enables the mobile platforms to exit the interior compartment of the container; and
alignment mechanisms operatively connected between the body and the launch elements such that the alignment mechanisms hold the launch elements within the interior compartment in fixed positions relative to each other.

12. The transport container of claim 11, wherein the alignment mechanisms are configured to hold bases of adjacent launch elements apart by a predetermined distance.

13. The transport container of claim 11, wherein the alignment mechanisms comprise at least one of a pallet, a rail, a floor grid, a rack, a palletized rack, pallets with at least one of the pallets being configured to interlock with at least one other pallet, pallets that interlock together into a grid of the pallets, or at least one rail that holds at least one of the launch elements.

14. The transport container of claim 11, wherein the alignment mechanisms comprise rails, the launch elements being configured to be loaded into the interior compartment by sliding along the rails.

15. The transport container of claim 11, wherein the alignment mechanisms comprise rails, at least one of the rails being configured to interlock with at least one of the launch elements at a location along a length of the rail.

16. A method comprising:
loading mobile platforms into an interior compartment of a transport container such that the mobile platforms are stacked on a launch element extending within the interior compartment;
operatively connecting a securing mechanism between the launch element and a top of the transport container such that an end portion of the launch element is configured to be received within a concave segment of the securing mechanism when the top is in a closed position; and
operatively connecting alignment mechanisms between the transport container and the launch elements such that alignment mechanisms hold the launch elements within the interior compartment in fixed positions relative to each other.

17. The method of claim 16, wherein operatively connecting the securing mechanism between the launch element and the top comprises operatively connecting the securing mechanism such that the concave segment of the securing mechanism is configured to limit a range of movement of the end portion of the launch element.

18. The method of claim 16, wherein operatively connecting the securing mechanism between the launch element and the top comprises at least one of:
moving the top from an open position to the closed position;
fixedly mounting the securing mechanism to the top; or
mounting the securing mechanism to the top such that the concave segment of the securing mechanism is free to move within a play relative to the top.

19. The method of claim 16, wherein operatively connecting alignment mechanisms between the transport container and the launch elements comprises at least one of:
interlocking at least one of the alignment mechanisms with at least one other alignment mechanism;
interlocking at least one of the alignments mechanism with at least one launch element;
mounting at least one launch element to at least one of the alignment mechanisms;
holding bases of adjacent launch elements apart by a predetermined distance; or
interlocking pallets of the alignment mechanisms together into a grid.

20. The method of claim 16, wherein the alignment mechanisms comprise rails and operatively connecting the alignment mechanisms between the transport container and the launch elements comprises at least one of:
holding at least one launch element with at least one of the rails; or
interlocking at least one rail with at least one of the launch elements at a location along a length of the rail.
